(19) United States
(12) Patent Application Publication
(10) Pub. No.: US 2020/0310690 A1
(43) Pub. Date: Oct. 1, 2020

(54) DYNAMIC NEAR-DATA PROCESSING CONTROL MECHANISM BASED ON COMPUTER RESOURCE AVAILABILITY ON SOLID-STATE DISK PLATFORMS

(71) Applicant: UNIVERSITY OF SOUTHERN CALIFORNIA, Los Angeles, CA (US)

(72) Inventors: Murali Annavaram, Los Angeles, CA (US); Gunjae Koo, Los Angeles, CA (US); Kiran Kumar Matam, Los Angeles, CA (US); Hung-Wei Tseng, Los Angeles, CA (US)

(21) Appl. No.: 16/650,758

(22) PCT Filed: Oct. 9, 2018
(86) PCT No.: PCT/US2018/055072

§ 371 Date: Mar. 25, 2020

Related U.S. Application Data
(60) Provisional application No. 62/570,554, filed on Oct. 10, 2017.

(51) Int. Cl. G06F 3/06; G06F 9/50

(52) U.S. Cl. CPC G06F 3/0659; G06F 3/0658; G06F 9/505; G06F 3/0613; G06F 3/0679; G06F 3/0631

(57) ABSTRACT

Methods, systems, and apparatus for near-store computing. The summarizer system includes a task controller. The task controller is configured to receive, from a host, a work item. The task controller is configured to determine a current workload of a storage controller on a solid state drive (SSD). The task controller is configured to determine a work strategy to utilize at least one of the host or the storage controller based on the current workload of the storage controller.

### CROSS-REFERENCE TO RELATED APPLICATIONS

This application claims priority to and the benefit of U.S. Provisional Patent Application No. 62/570,554 titled “DYNAMIC NEAR-DATA PROCESSING CONTROL MECHANISM BASED ON COMPUTER RESOURCE AVAILABILITY ON SOLID-STATE DISK PLATFORMS,” filed on Oct. 10, 2017, and the entirety of which is hereby incorporated by reference herein.

### STATEMENT REGARDING GOVERNMENT RIGHTS

This invention was made with Government support under Grant No. 0954211 awarded by the National Science Foundation (NSF). The Government has certain rights in this invention.

### BACKGROUND

### Field

This specification relates to a system, a method or an apparatus for offloading data intensive tasks and/or computations.

### Description of the Related Art

Modern data center solid state drives (SSDs) integrate multiple general-purpose embedded cores to manage flash translation layer, garbage collection, wear-leveling, etc., to improve the performance and the reliability of SSDs. As the performance of these cores steadily improves there are opportunities to repurpose these cores to perform application driven computations on stored data, with the aim of reducing the communication between the host processor and the SSD. Reducing host-SSD bandwidth demand cuts down the input/output (I/O) time which is a bottleneck for many applications operating on large data sets. However, the embedded core performance is still significantly lower than the host processor, as generally lower performance embedded cores are used within SSDs for cost effective reasons. Thus, there is a tradeoff between the computation overhead associated with near SSD processing and the reduction in communication overhead to the host.

Accordingly, there is a need to offload data intensive tasks to balance computation overhead with communication overhead.

### SUMMARY

In general, one aspect of the subject matter described in this specification may be embodied in a summarizer system. The summarizer system automatically scales near-storage computing capability. The summarizer system includes a task controller. The task controller is configured to receive, from a host, a work item. The task controller is configured to determine a current workload of a storage controller on a solid-state drive (SSD). The task controller is configured to determine a work strategy to utilize at least one of the host or the storage controller based on the current workload of the storage controller.

These and other embodiments may optionally include one or more of the following features. The host may be a motherboard embedded in the storage controller. The task controller may be at least one of a software module stored in the storage controller or a separate control module coupled to the storage controller. The task controller may continuously determine the current workload of the storage controller. The summarizer system may include a user function stack. The user function stack may be configured to store multiple work items. The multiple work items may include at least one of function calls, a series of instructions or a sequence of steps. The summarizer system may include a task queue. The task queue may be configured to store a pointer to a work item of the multiple work items stored in the user function stack. The work division strategy may utilize both the host and the storage controller.

In another aspect, the subject matter may be embodied in a system. The system includes a host configured to provide a work item to be executed. The system includes a solid state drive having a storage controller. The system includes a summarizer having a task controller. The task controller is configured to receive, from the host, the work item. The task controller is configured to determine a current workload of the storage controller. The task controller is configured to determine a work division strategy to utilize at least one of the host or the storage controller based on the current workload of the storage controller.

In another aspect, the subject matter may be embodied in a method. The method includes receiving, from a host, a work item. The method includes determining a current workload of a storage controller on a solid-state drive (SSD). The method includes determining a work division strategy that utilizes at least one of the host or the storage controller based on the current workload of the storage controller.

### BRIEF DESCRIPTION OF THE DRAWINGS

Other systems, methods, features, and advantages of the present invention will be apparent to one skilled in the art upon examination of the following figures and detailed description. Component parts shown in the drawings are not necessarily to scale, and may be exaggerated to better illustrate the important features of the present invention.

FIG. 1 shows an example summarizer system using a summarizer to form a work division strategy according to an aspect of the invention.

FIG. 2 shows a more in-depth diagram of the in-SSD task control used by the summarizer system of FIG. 1 according to an aspect of the invention.

FIG. 3 is a flow diagram of an example process of a host device of the summarizer system of FIG. 1 requesting the execution of a work item, such as a task, according to an aspect of the invention.

FIG. 4 is a flow diagram of an example process of an SSD device of the summarizer system of FIG. 1 relaying the task to the summarizer according to an aspect of the invention.

FIG. 5 is a flow diagram of an example process of the summarizer of the summarizer system of FIG. 1 distributing the task for execution according to an aspect of the invention.

FIGS. 6A-6D show the execution time by the ratio of in-SSD computation for different data sets according to an aspect of the invention.

FIG. 7 shows the performance improvement by internal/external bandwidth ratio for different data sets according to an aspect of the invention.

FIG. 8 shows the performance improvement by SSD controller's computation power for different data sets according to an aspect of the invention.

### DETAILED DESCRIPTION

Disclosed herein are systems, apparatuses, devices and/or methods for a summarizer system. The summarizer system is an architecture and/or computing model that allows applications to make use of solid-state drive (SSD) processors for filtering and summarizing data stored in SSD before transferring the data to the host. The summarizer system reduces the amount of data moved to the host processor and allows the host processor to compute on filtered/summarized results thereby improving the overall system performance. Traditional magnetic disk storage systems have both seek and rotational latencies that dominate data access time. However, with the rapid adoption of solid state non-volatile storage technologies the performance bottleneck shifts from medium access time to the operating system overheads and interconnection bandwidth. Modern SSDs for data centers integrate large dynamic random access memory (DRAM) buffers as well as general-purpose embedded cores that are often under-utilized, and so, moving the computation closer to the data storage becomes feasible. High-end data center SSDs are equipped with lower power embedded cores. Even these embedded cores are under-utilized and have considerable slack since these cores only need to occasional work to manage the non-volatile storage. The non-volatile storage for instance can be a NAND or NOR flash memory and in which case the embedded core may need to handle wear levelling and garbage collection. The non-volatile storage can also be other types of memory such as phase change or spin torque memories. Offloading large computation kernels to these embedded cores, however, is impractical. There is a tradeoff as the embedded cores require a much longer processing time compared to computing on host processors, and so, there is a tradeoff between the computation overhead suffered by embedded cores and the reduction in communication latency to transfer data to the host system.

The summarizer system, however, is a near storage computing paradigm that uses the near-storage computing power opportunistically whenever it is beneficial to offload computation. The summarizer system automatically balances the communication delay with the computing limitations of near-storage processors.

Other benefits and advantages include that the summarizer system may be implemented on a custom-built flash storage that resembles existing SSD architectures but also enables fine grain computational offloading between the storage processor and the host. In some implementations, the summarizer system is implemented using standard non-volatile memory express (NVMe) interface commands, without changing the NVMe compatibility.

Additionally, the summarizer system apportions the division of labor and monitors the amount of workload at the SSD processor. The summarizer system selects the appropriate division strategy among the host processor and the SSD processor. The summarizer system has a work division approach that quantifies the potential of using both the host processor and the SSD processor in tandem to get better performance. The summarizer system may rely on the processing capabilities embedded in modern SSDs and the NVMe commands used by the host to interface with the SSDs.

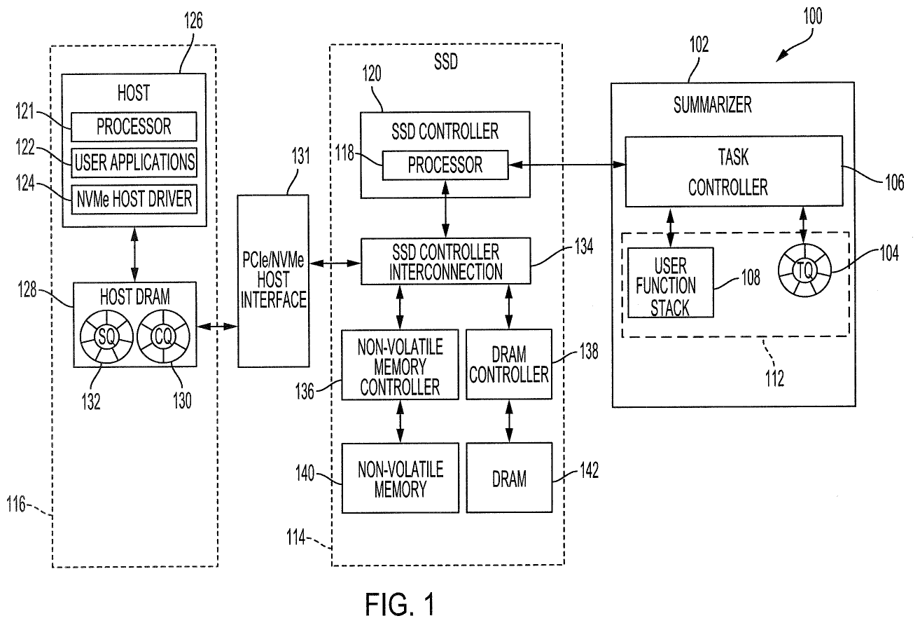

FIG. 1 shows a summarizer system 100 using a summarizer 102 to form a work division strategy. The summarizer system 100 may automatically scale near-storage computing capability. The summarizer system 100 includes the summarizer 102, the SSD device 114, and/or the host device 116. The summarizer system 100 may have various queues or data structures, such as the task queue 104, the submission queue 132, the completion queue 130, the request queue 204 and/or the response queue 206. The various queues may be implemented as an ordered or prioritized queue, such as a circular queue, a priority queue, a first-in-first-out (FIFO), a last-in-first-out (LIFO) or other queue or data structure.

The summarizer 102 controls, manages or otherwise determines the division of workload or the work division strategy between a host (e.g., the host device 116) and the SSD device 114. Summarizer-enabled SSDs allow the host device 116 to associate a specific user-defined function to be executed on the SSD device 114 with every data access request.

The summarizer 102 includes a task controller 106 and may include a task queue 104 and a user function stack 108. The summarizer 102 may have a memory 112 that stores the task queue 104 and/or the user function stack 108.

The memory 112, the host dynamic random access memory (DRAM) 128 or other memory may be a non-transitory memory or a data storage device, such as a hard disk drive, a solid-state disk drive, a hybrid disk drive, or other appropriate data storage. The memory 112, the host DRAM 128 or other memory may further store machine-readable instructions, which may be loaded and executed by one or more processors.

The summarizer 102 may include a task queue structure (“task queue”) 104. The task queue 104 may be a circular queue, a priority queue, a first-in-first-out (FIFO), a last-in-first-out (LIFO) or other queue or data structure. The task queue 104 may store a pointer to a corresponding user function, e.g., a user function on the user function stack 108, that is invoked when the host device 116 requests an in-SSD processing on a given input/output (I/O) request. The task queue 104 may be stored in the memory 112. The task queue 104 identifies the actual tasks and the amount or number of tasks loaded for implementation by the SSD processor 118. When the task queue 104 is full, i.e., there are no available slots for tasks to be stored for execution consideration on the SSD processor, the task controller 106 may indicate to the host processor that the task queue 104 is full and return the requested task to the host device 116 for implementation by the host device 116. When the task queue 104 has empty slots, the task controller 106 may queue the requested task into the task queue 104 for execution on the SSD device 114. The task queue 104 allows for the task controller 106 to make a decision on where to execute a work item or task anytime while the tasks are waiting in the task queue, which allows the summarizer 102 to determine if execution may or may not be executed on the SSD device 114 or on the host device 116 at a later time.

In some implementations, the summarizer 102 does not have a task queue 104 and/or a user function stack 108. When the summarizer 102 does not have the task queue 104, the task controller 106 may directly probe or request resource utilization information or availability of the SSD processor 118 to process or execute the task, and if there is sufficient resources and/or availability, the SSD processor 118 may execute the task instead of having the task controller 106 place the task on the task queue 104.

The summarizer 102 includes a task controller 106. The task controller 106, the host processor 121, the SSD processor 118 or other processor, storage controller or controller, such as the SSD controller 120 and/or the DRAM controller 138, may include a single processor or controller or multiple processors and/or controllers. The functions performed on these processors or controllers may be implemented on the single processor or controller or on the multiple processors and/or controllers.

The task controller 106 may be coupled to the task queue 104 and/or the user function stack 108. The task controller 106 determines the work division strategy. The task controller 106 dynamically selects and determines whether to execute a task on the SSD device 114 or other device, such as the host device 116. The task controller 106 decides whether the in-SSD processing is performed for the fetched page data or not. If the task controller 106 decides to execute in-storage computation, the target function may be executed from the user function stack 108. In some implementations, the task controller 106 may not perform in-SSD processing even if the host device 116 requests for such processing.

The task controller 106 may be a hardware device or a software application stored within a memory and executed on a processor that receives a work item, such as a function call, a series of instructions or steps, or other function call, and determines a work division strategy. The task controller 106 may be coupled to the SSD processor 118 where the task controller 106 requests the amount of computing cycles or resource utilization of the SSD processor 118 to execute a function and determines the work division strategy based on the availability of the amount of computing cycles or resources.

The task controller 106 may have multiple modes, such as a static mode and/or a dynamic mode. In the static mode, whenever the in-SSD computing flag is set, the computation is completed on the fetched data irrespective of the processing delay of the SSD processor 118. In the static mode, when in-SSD computation request is not possible since the task queue 104 is full, the return process is stalled. When in the dynamic mode, if in-SSD computation is delayed in the SSD controller 120 due to lack of computation resources, the buffered page data is transferred to the host 126 even if the host 126 requests an explicit near storage processing command. This may occur when the service rate or the execution time of the SSD processor 118 is slower compared to the incoming rate of in-SSD computation requests. Such congestion may happen in the presence of SSD cores if near data processing is applied aggressively on fetched data.

The summarizer 102 may include a user function stack 108. The user function stack 108 may be stored in a memory 112. The user function stack 108 stores a list, a queue or other database or data storage structure that has one or more user function calls, commands or other instructions to be implemented or executed by one or more processors on one or more computing devices, such as the SSD device 114 or the host device 116. In some implementations, the one or more user function calls, commands or other instructions are not stored within a user function stack 108, but instead, the summarizer 102 may receive the one or more user function calls, commands or other instructions, e.g., from a command or other instruction from the SSD device 114 or the host device 116. The one or more user function calls, commands or other instructions may be included in the command or other instruction from the SSD device 114 or the host device 116. The SSD processor 118 may directly implement the function, the command, the user function call or other instruction instead of retrieving the function, the command, the user function call or other instruction from the user function stack 108.

The host device 116 may control, command or otherwise instruct the SSD device 114. The host device 116 may be a laptop, a computer, a smartphone, or other computing device, such as a motherboard. In some implementations, the host device 116 and the SSD device 114 are a single integrated device that has multiple processors, such as the host processor 121 and the SSD processor 118. For example, one device, such as the host device 116 or SSD device 114, may be embedded within the other device, such as the SSD device 114 or the host device 116, respectively, to form a single integrated device. The host device 116 associates specific user-defined functions to be executed on the SSD device 114 with every data access request. The host device 116 implements an NVMe command interface between the host device 116 and the SSD processor 118. NVMe is a protocol that avoids disk-centric legacy interfaces to provide scalable bandwidth. NVMe also supports more concurrent input/output requests than serial advanced technology attachment (SATA) or small computer system interface (SCSI) by maintaining a software command queue. NVMe is highly scalable and capable of servicing multiple input/output (I/O) requests in parallel. An NVMe command may also contain a list of physical region page entries which enables scatter-gather data transfers between the SSD and other devices.

The host device 116 includes a host 126. The host 126 may include a host processor 121, one or more user applications 122, and/or a host driver 124, such as an NVMe host driver. The host device 116 may include a host dynamic random access memory (DRAM) 128 or other volatile or non-volatile memory, which stores a completion queue 130 and/or a submission queue 132.

The host 126 includes a host processor 121. The host processor 121 may be coupled to the one or more user applications 122 and/or the host driver 124. The one or more user applications 122 may request, initiate or execute function calls, command or other instructions on one of the one or more processors. The host processor 121 in conjunction with the host driver 124 may initiate one or more NVMe commands, such as INIT_TSKn, READ_PROC_TSKn, READ_FILT_TSKn, FINAL_TSKn, to perform initialization, computation and/or finalization operations. The initialization command, INITTSKn, informs the task controller 106 that the host 126 intends to execute a user-defined task (“task”), for example. The host processor 121 may initialize any local variables or any temporary data that may be used by that task.

The one or more NVMe commands, such as the READ_PROC_TSKn, may include a task identifier, e.g., a task ID, within the command that identifies the task that is to be executed, e.g., on the SSD controller 120. The task ID specifies the desired task that may be executed on the SSD controller 120 once a page is read from the memory. In another example, the read/process command, READ_PROC_TSKn, reads page data and executes the computation kernel for task n with the data. In another example, the read/filter command, READ_FILT_TSKn, reads page data and filters the data by predefined queries. In another example, the finalization command, the FINAL_TSKn transfers outputs to the host 126.

The host dynamic random access memory (DRAM) 128 may store a completion queue 130 and/or a submission queue 132. The completion queue 130 resides on the host DRAM 128 and obtains submitted commands by having the NVMe command and a return code registered on the completion queue 130. After NVMe handling of the command is complete, the SSD controller 120 may notify completion of a previously submitted command by registering the previously submitted command on the completion queue 130. When the host driver 124 issues the NVMe command, the host driver 124 registers the NVMe commands on the submission queue 132 to indicate that the NVMe command has been issued. The host 126 may send a doorbell signal to the SSD controller 120 to notify the SSD controller 120 of a new command request from the host 126.

The summarizer system 100 may include a Peripheral Component Interconnect Express (PCIe)/NVMe Host Interface 131. A PCIe is a high-speed serial computer expansion bus interface. The PCIe/NVMe Host interface 131 is a bus interface between the host device 126 and the SSD device 114, e.g., in between the host processor 121 and the SSD controller 120 via the SSD controller interconnection 134.

The SSD device 114 includes an SSD controller 120, an SSD controller interconnection 134 and other controllers, such as the non-volatile memory controller 136 and/or the DRAM controller 138, and other memory, such as the non-volatile memory 140 and the SSD DRAM 142. The SSD device 114 communicates with the host device 126 via the SSD controller interconnection 134. Moreover, the SSD controller interconnection 134 provides an interface between the SSD controller 120 and access to the different types of memory, such as the non-volatile memory 140 and/or the SSD DRAM 142 via the non-volatile memory controller 136 and/or the DRAM controller 138. The non-volatile memory controller 136 controls or manages the non-volatile memory 140, and the DRAM controller 138 controls or manages the SSD DRAM 142, respectively. The non-volatile memory 140 may be a NAND flash, a NOR flash, a PC face change memory (PCM), or other non-volatile memory.

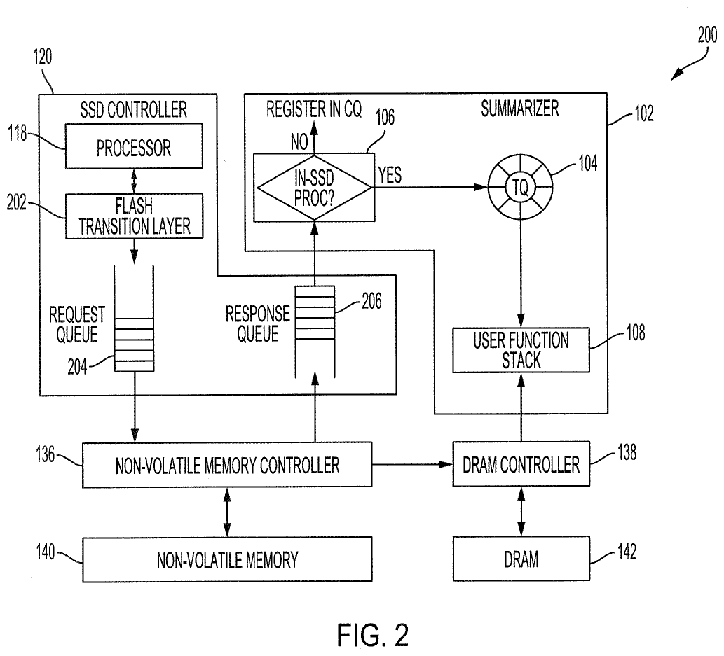

The SSD controller 120 may have an SSD processor 118 that performs input/output (I/O) control. The SSD controller 120 may have a flash translation layer (FTL) 202 to perform FTL processing, as shown in FIG. 2 for example. The SSD processor 118 may be an embedded processor. The SSD controller 120 may perform FTL processing using the SSD processor 118. The SSD controller 120 receives request commands from the host 126 by reading the registered request from the submission queue 132. For example, the SSD controller 120 may read the registered request from the head of the submission queue 132, while the host driver 124 registers the request at the tail of the submission queue 132. The SSD controller 120 fetches requests from the submission queue 132 to be read and executed. Once the requests are read and executed, the SSD controller 120 registers the completion of the request on the completion queue 130.

FIG. 2 shows a more in-depth diagram of the in-SSD task control used by the summarizer system 100. The SSD controller 120 may include a flash translation layer 202, a request queue 204 and/or a response queue 206. The SSD controller 120 uses the flash translation layer 202 to perform flash translation processing. The NVMe command that is fetched may be decoded into single or multiple page-level block I/O commands. Each page-level request has a logical block address, which is translated to a physical page number by the FTL processing.

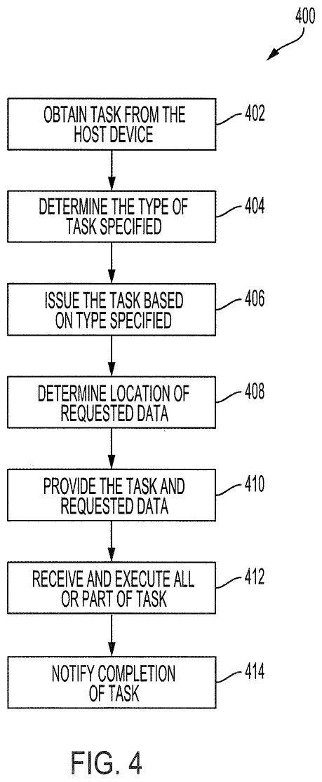

The SSD controller 120 utilizes the request queue 204 to interact and communicate with the non-volatile memory controller 136, such as a flash memory controller, to fetch page data from a location on the non-volatile memory 140, such as a NAND chip, which has the requested data to be placed on the response queue 206. The requested page data is fetched from the non-volatile memory 140 through one or more physical page reads and the fetched data is buffered in the DRAM on the SSD device 114. The page data may be transferred to the host device 116 via the host DRAM 128. The SSD controller 120 determines the location of the requested data within the non-volatile memory 140 and places the requested data on the response queue 206 to deliver or provide to the summarizer 102. FIG. 4 further describes the role of the SSD device 114.

In addition, the SSD controller 120 may recognize that the host 126 is requesting an in-SSD processing for the data request and the processing task is specified in the task ID field. The SSD controller 120 adds the data request to the task queue 104 or otherwise provides the data request to the task controller 106. The non-volatile memory controller 136 processes the data request by accessing the appropriate channel and chip IDs. The data is fetched and may be buffered in the SSD DRAM 142 and a completion signal may be sent to the response queue 206, which may be sent back to the host 126 by the SSD controller 120. The SSD controller 120 may check an in-SSD computing flag bit to determine whether in-SSD processing is requested. If in-SSD computing is selected, the task controller 106 determines whether in-SSD processing is performed.

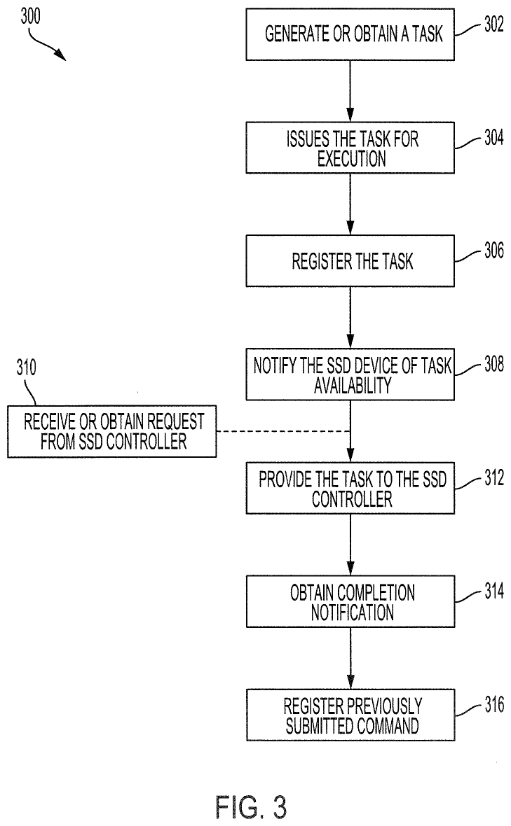

FIG. 3 is a flow diagram of a process 300 of a host device 116 of the summarizer system 100 requesting the execution of a work item, such as a task. One or more computers or one or more data processing apparatuses, for example, the host 126 or the host processor 121 of the host device 116 of the summarizer system 100 of FIG. 1, appropriately programmed, may implement the process 300.

The host device 116 may generate or obtain a work item (or “task”), such as an NVMe command, function call, request or other user-defined task (302). The task may have a particular type, such as a command, function call or other instruction. The task may be identified using a task identifier (or “task ID”). The task ID may be stored or otherwise included in the task. In particular, the one or more user applications 122 within or stored on the host 126 may generate the task using the host processor 121 and associate the task with a user-function call. The host processor 121 may provide the generated task to the host driver 124.

Once generated, the host device 126 issues the task for execution (304). The host device 126 may use the host driver 124 to issue the task. Once the task is issued, the host device 126 registers the task (306). The host device 126 uses the host driver 124 to register the task on the submission queue 132. The host driver 124 may place the task on the submission queue 132 within the host DRAM 128 to register and issue the task.

When the task is registered on the submission queue, the host device 126 may notify the SSD device 114, such as by sending a doorbell signal, that the task is available on the submission queue 132 via the PCIe/NVMe Host Interface 131 (308). In some implementations, the host device 126 may receive or otherwise obtain a request from the SSD controller 120 for the task (310) and in response, provide the task to the SSD controller 120 (312). In some implementations, the SSD controller 120 reads the task directly from the submission queue 132 and no active request is received by the host device 126.

The host device 126 awaits and obtains a completion notification (314). The host device 126 may receive the completion notification from the SSD controller 120. The completion notification may include the NVMe command that was initiated and a return code to indicate that the NVMe command was submitted.

The host device 126 registers the previously submitted command on the completion queue 130 within the Host DRAM 128 (316). This indicates to the host device 126 that the command has been completed. The completion queue 130 resides on the host DRAM 128 and obtains submitted commands by having the NVMe command and a return code registered on the completion queue 130.

FIG. 4 is a flow diagram of a process 400 of an SSD device 114 of the summarizer system 100 relaying the task to the summarizer 102 of the summarizer system 100. One or more computers or one or more data processing apparatuses, for example, the SSD controller 120 or the SSD processor 118 of the SSD controller 120 of the summarizer system 100 of FIG. 1, appropriately programmed, may implement the process 400.

The SSD device 114 obtains the task from the host device 126 via the PCIe/NVMe Host Interface 131 (402). The SSD device 114 may use the SSD controller 120, e.g., using the SSD processor 118, to request, read or otherwise obtain the task from the submission queue 132 of the Host DRAM 128. The SSD controller 120 may periodically or regularly check the submission queue 132 for an available task. In some implementations, the SSD controller 120 obtains a doorbell signal that notifies the SSD device 114 that the task is available on the submission queue 132. In some implementations, the SSD processor 118 requests and receives the task from the host device 126 in response to the request. The SSD controller 120 may fetch host request commands as long as the registered request exists on the submission queue 132.

Once fetched, the SSD device 114 may determine the type of task specified (404). For example, the SSD processor 118 may parse or extract bits from the task to identify the task ID that indicates or identifies the type of task. The task may be a computation task, such as a read and process or a read and filter request, an initialize task and/or a finalize task. The read and process request is a request to read page data and execute the computation kernel for the task. The read and filter request is a request to read page data and filter the data by predefined queries. The finalize task transfers the output to the host device 126. The initialize task initializes the variable or set queries.

The SSD device may issue the task based on the type of task specified (406). For example, the SSD controller 120 identify that the task is a read request and request the non-volatile memory controller 136, such as a flash memory controller, to fetch page data from the non-volatile memory 140. The SSD controller 120 may issue the read request by placing the read request on the response queue 206. The non-volatile memory controller 136 will take the read request from the response queue 206 and determine the location on the non-volatile memory 140 which has the requested data to be placed on the response queue 206. The non-volatile memory controller 136 places the requested data on the response queue 206 once the location of the data within the non-volatile memory 140 is identified. The handling of the request is further described above in FIG. 2.

In some implementations, the SSD controller 120 requests filtering in addition to a read request. A filtering request is a request to filter the data and transfer the filtered data to the host device 126. A filtering task may result in a part of the computation task being performed on the host processor 121 and another part of the computation task being performed and offloaded on the SSD processor 118. For example, the filtering task may use a simple compare operation on specific data fields within a page to remove some data that is not needed at the host 126. The filtering conditions may be pre-defined during the initialization. When complete, the filtering execution may be registered on the completion queue 130.

In some implementations, the SSD controller 120 sets a flag, such as an in-SSD compute flag, to identify to the summarizer 102 that the host 126 has requested or associated in-SSD processing with the task.

The SSD device 114 determines the location of the requested data, as described above in FIG. 2 (408) and provides the task and requested data to the summarizer 102 (410). The SSD controller 120 may directly interact and provide the task and requested data to the task controller 106. In some implementations, the SSD controller 120 places or adds the task and/or requested data onto the task queue 104 to allow for delayed processing by the task controller 106.

The SSD device 114 may receive and/or execute the task for processing from the task controller 106 (412). The SSD processor 118 may process all or part of the task. That is, the SSD processor 118 executes the task. After NVMe handling of the task is complete, the SSD controller 120 may notify completion of a previously submitted command or task by registering the previously submitted command or task on the completion queue 130 (414).

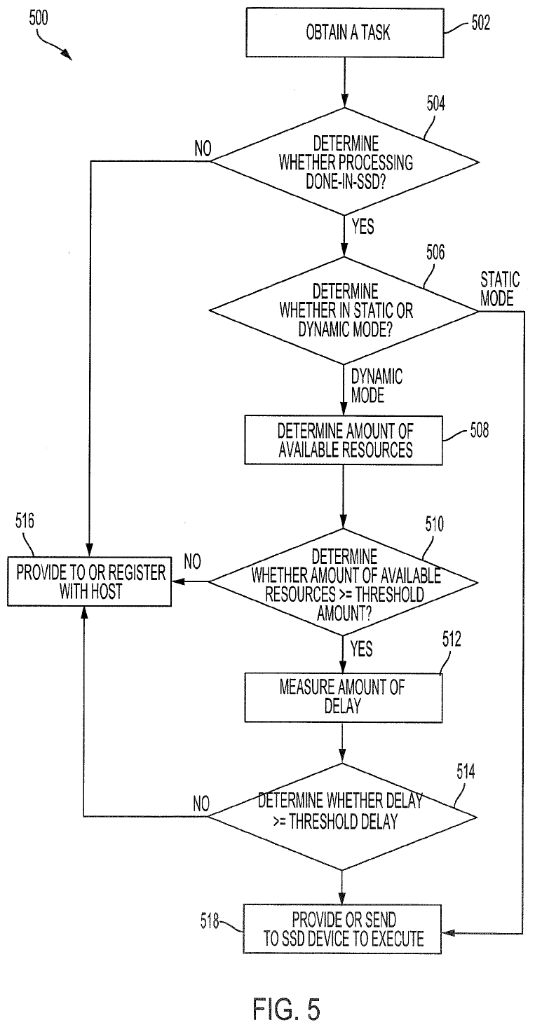

FIG. 5 is a flow diagram of a process 500 of the summarizer 102 of the summarizer system 100 distributing the task for execution. One or more computers or one or more data processing apparatuses, for example, the task controller 106 of the summarizer system 100 of FIG. 1, appropriately programmed, may implement the process 500.

The summarizer 102 piggybacks on page-level flash read operations to execute user-defined functions before returning processed data to the host. The summarizer 102 may require that the data sets in a page size memory space to be aligned.

The summarizer 102 obtains a task (502). The summarizer 102 may read the task from the SSD Device 114. For example, the SSD controller 120 may have a response queue 206, and the summarizer 102 may read the task from the response queue 206. In some implementations, the task controller 106 obtains the task directly from the SSD controller 120.

Once the summarizer 102 obtains the task, the summarizer 102 determines whether the processing of the task is to be done on the SSD device 114 (504). The summarizer 102 may read information included within the task to determine whether the host device 126 has indicated that the task should be performed and/or executed on the SSD device 114. For example, the task may be tagged with an identifier or flag, such as the SSD compute flag that indicates whether the host device 126 has indicated that the task should be performed and/or executed on the SSD device 114. The summarizer 102 reads the flag and may determine whether the SSD device 114 is used in processing the task based on the read flag. If the flag indicates that the processing is not to be done on the SSD device 114, the summarizer 102 provides or returns the task to the host 126 for processing (516). Even if the flag indicates that the processing is to be done on the SSD device 114, the summarizer 102 does not necessarily execute or perform the processing on the SSD device 114. The summarizer 102, instead, continues evaluating if other conditions are met to allow for processing on the SSD device 114.

In response to determining that the flag is set to in-SSD processing, the summarizer 102 may determine whether the task controller 106 is in a static mode or dynamic mode (506). The summarizer 102 may check a mode indicator, setting or other flag that identifies which mode to enable. The mode indicator, setting or other flag may be toggled or otherwise adjusted by user input or may be pre-configured. If the task controller 106 is set to the static mode, the task is sent or provided to the SSD device 114 to execute, i.e., the task controller 106 causes in-SSD processing. The task is sent or provided to the SSD device 114 to execute regardless or irrespective of the amount of delay required for the SSD processor 118 to process the task.

If the task controller 106 is set to the dynamic mode, the summarizer 102, in response, determines the amount of available resources that is available to the SSD controller 120 and/or the SSD processor 118 (508). In other words, the summarizer 102 determines the workload of the SSD device 114 and determines a work division strategy to offload one or more tasks to the SSD device 114, which allows some tasks to be performed on the SSD device 114 and other tasks to be performed by the host device 116. The work division strategy determines the location that processes the task, such as the user function call or command. For example, the work division strategy may determine that the task is implemented on the SSD processor 118 or the host processor 121.

The summarizer 102 may continuously and/or periodically monitor the workload and/or the amount of available resources. In some implementations, the summarizer checks the workload and/or the amount of available resources on-demand.

For example, the task controller 106 may query the SSD controller 120 to determine the amount, ratio or percentage of resources that are currently utilized and/or not utilized. The resources may include the bandwidth, amount of memory, computer cycles or other computer resources within the SSD controller 120. In another example, the task controller 106 determines whether the task queue 104 is full or does not have available slots to add a task to the task queue 104. If the task queue 104 is full or does not have any available slots to add the task, the task controller 106 may determine that there are no available resources for the SSD processor 118. That is, the amount of the available resources is less than a threshold amount.

Once the amount of available resources is determined, the summarizer 102 may determine whether the amount of available resources is greater than or equal to a threshold amount (510). The summarizer 102 may use the task controller 106 to determine resource availability. The threshold amount may be equivalent to the amount of resources necessary for the task to execute or the number of available slots to add a task onto the task queue 104.

In some implementations, the threshold amount may be greater than the amount of resources for the task to execute. The threshold amount may include a safety margin so as to prevent the SSD controller 120 and/or the SSD processor 118 from being fully utilized, such as resource utilization below 100% and/or one or more empty slots on the task queue 104. The task controller 106 may estimate a maximum amount of resources necessary to process the task and compare the maximum amount of resources necessary to the amount of available resources on the SSD controller 120 and/or the SSD processor 118. This allows for the task controller 106 to account for spikes in resource utilization demands.

In some implementations, the summarizer 102 determines that the amount of available resources is greater than or equal to the threshold amount when the task queue 104 is not full or when the task queue 104 has enough empty slots.

When the summarizer 102 determines that there is sufficient resources for in-SSD processing, e.g., there are available slot on the task queue 104 or the amount of available resources is greater than or equal to the threshold amount, the summarizer 102 may measure or determine the amount of delay for the processing to occur (512). The summarizer 102 may estimate or count the number of tasks within the task queue 104 to determine the amount of delay for in-SSD processing. The summarizer 102 may identify the types of tasks on the task queue prior to adding the task to the task queue. The summarizer 102 may estimate the amount of delay based on the types of tasks and the number of each type of task on the task queue 104. Some tasks may be more resource intensive than other tasks, and thus, the more resource intensive task would cause a longer delay, for example.

The summarizer may determine whether the estimated amount of delay is greater than or equal to a threshold delay, such as 10 ms, or that the task queue 104 is full (514). If the amount of delay is greater than or equal to the threshold delay, the task queue 104 is full or the amount of available resources of the SSD processor 118 and/or the SSD controller 120 is less than the threshold amount, the summarizer 102 may provide the task to the host 126 for processing (516).

If the amount of delay is less than the threshold delay or the summarizer is in a static mode and the delay is not considered, the summarizer 102 places the task on the task queue 104 or provides or sends the task to the SSD device 114 to execute (518). The summarizer 102 may directly provide the task to the SSD controller 120 and/or the SSD processor 118 and/or the summarizer 102 may place the task on the task queue 104. When the resources become available, the task controller 106 sends the task to the SSD processor 118 to execute.

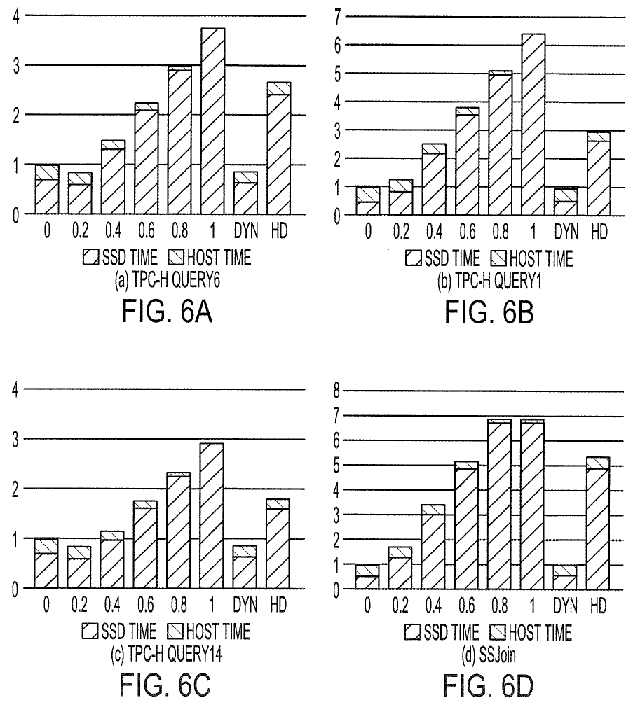

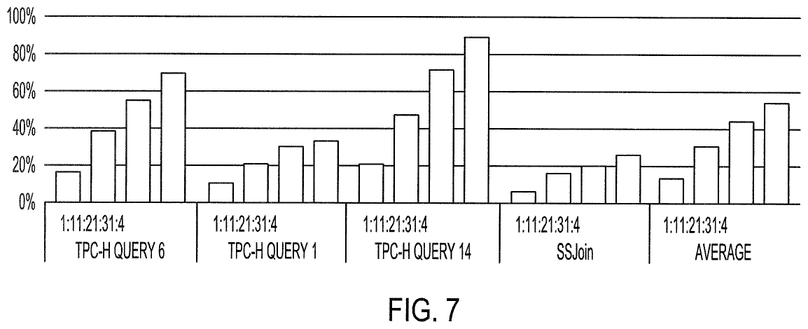

FIGS. 6A-6D and 7 show experimental performance of the in-SSD processing described above. The summarizer 102 was evaluated using an industrial strength flash-based SSD development board equipped with a multi-core ARM processor executing the SSD controller firmware programs (including FTL management, wear-leveling, garbage collection, NVMe command parsing and communication with the host), and an FPGA where the flash error correction logic and NAND flash memory controller logic are implemented. The ARM processor may run at a faster peak clock frequency of 1.6 GHz.

FIGS. 6A-6D show the execution time by the ratio of in-SSD computation for different data sets TPC-H query 6, as shown in FIG. 6A for example, TPC-H query 1, as shown in FIG. 6B for example, TPC-H query 14, as shown in FIG. 6C for example, and Similarity Join (SSJoin), as shown in FIG. 6D for example. The different data sets have the following processing by I/O ratio:

| Data Set | Processing by I/O Ratio |
|---|---|
| TPC-H query 6 | 0.42 |
| TPC-H query 1 | 1.08 |
| TPC-H query 14 | 0.39 |
| Similarity Join | 0.93 |

The results where the X-axis shows specific numbers between 0 and 1 correspond to the static mode operation of the summarizer 102. The results where the X-axis shows the DYN label represents results obtained using the dynamic mode of the summarizer 102. In the dynamic mode, all page fetch requests from the host processor 121 are issued using the READ_PROC_TSKn commands. The summarizer 102 dynamically decides the in-SSD computation for the requested pages. HD means hand-coded task offloading for in-SSD computation. Simple tasks (e.g. a database field filtering function) are performed in the SSD to reduce data traffic. The READ_FILT_TSKn NVMe command is exploited to perform filtering operations in the HD mode.

Each execution time bar is split into two components: time spent on the host side (labeled as host time in the bar), and time spent on the SSD side (labeled as SSD time). When using the baseline (x-axis label 0) the time spent on the SSD side is purely used to read the NAND flash pages and transfer them to the host. But for the other bars the time spent on the SSD side includes the time to read and process a fraction of the pages on the SSD. Clearly processing only at the SSD (X-axis labeled 1) leads to significant performance degradation since the data computation takes longer on the SSD controller core. The hand-coded version (labeled HD) provides better performance than the static page-level SSD computation for all or large percentage of pages but in general hand-coding is a static approach that does not adapt to changing system state. As the embedded cores on the SSD get overloaded, even though filtration tasks do not require lots of computation resources the results show that the static in-SSD offloading approach is ineffective as the I/O request rates exceed service rate of embedded cores. The results shown in FIGS. 6A-6D demonstrate that placing all computation on host processor or SSD processor does not deliver the best performance. There is a sweet spot where collaborative computation between the SSD and host gives the best performance. This sweet spot varies from workload to workload and may even vary based on the input data. In the dynamic mode, the summarizer 102 dynamically decides where the user application functions are performed by observing the availability of the SSD processor 118, which reduces the burden of programmers in deciding the division of in-SSD computing to achieve better performance while exploiting the computation resources in the SSD.

The performance improvement in the query processing when the summarizer 102 is in the dynamic mode. The query processing is improved by 16.4%, 10.3% and 20.3% for queries 6, 1, and 14, respectively. For similarity join the performance is improved by 6.9%. The performance improvements achieved in the dynamic mode are not due simply to the availability of additional CPU resources but also from reduced I/O processing times. FIG. 7 shows the performance change as a function of the ratio of internal data bandwidth between the SSD controller 120 and non-volatile memory 140 and external bandwidth of PCIe between the host processor 121 and the SSD processor 118 for each of the different datasets.

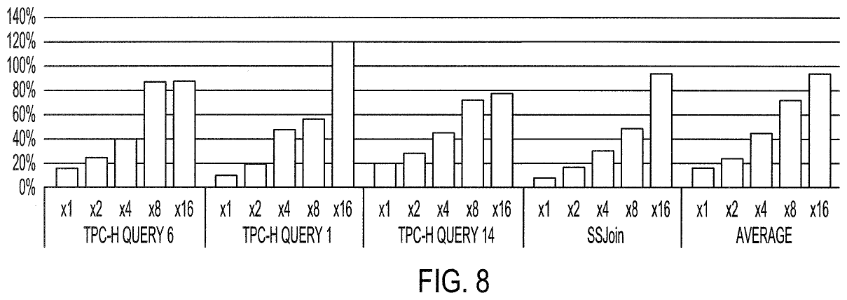

FIG. 8 shows the performance change as a function of improved computation power of the SSD controller 120 when the summarizer 102 runs in dynamic mode for each of the different datasets. The results show that the overall performance can be improved by up to 120% for query 1 and 94.5% on average with in-SSD computation when the performance of the SSD controller 120 is increased by 16×. The summarizer 102 reduces data congestion by consuming page data with in-SSD computation, and so, the summarizer 102 not only releases the computation burden of the host processor 121 but reduces the data traffic from the SSD. Thus, the external bandwidth is improved because more pages are responded to the host 126 within the same period.

Exemplary embodiments of the invention have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A summarizer system that automatically scales near-storage computing capability, the system comprising:
a task controller configured to:
receive, from a host, a work item,
determine a current workload of a storage controller on a solid state drive (SSD), and
determine a work division strategy to utilize at least one of the host or the storage controller based on the current workload of the storage controller.

2. The summarizer system of claim 1, wherein the host is a motherboard embedded in the storage controller.

3. The summarizer system of claim 1, wherein the task controller is at least one of a software module stored in the storage controller or a separate control module coupled to the storage controller.

4. The summarizer system of claim 1, wherein the task controller continuously determines the current workload of the storage controller.

5. The summarizer system of claim 1, further comprising a user function stack that is configured to store a plurality of work items.

6. The summarizer system of claim 5, wherein the plurality of work items are at least one of function calls, a series of instructions, or a sequence of steps.

7. The summarizer system of claim 6, further comprising a task queue configured to store a pointer to a work item of the plurality of work items stored in the user function stack.

8. The summarizer system of claim 1, wherein the work division strategy utilizes both the host and the storage controller and merges the partial results from the storage controller with the results from the host.

9. A system comprising:
a host configured to provide a work item to be executed;
a solid state drive (SSD) having a storage controller; and
a summarizer having a task controller configured to:
receive, from the host, the work item,
determine a current workload of the storage controller, and
determine a work division strategy to utilize at least one of the host or the storage controller based on the current workload of the storage controller.

10. The system of claim 9, wherein the host is a motherboard embedded in the storage controller.

11. The system of claim 9, wherein the task controller is at least one of a software module stored in the storage controller or a separate control module coupled to the storage controller.

12. The system of claim 9, wherein the task controller continuously determines the current workload of the storage controller.

13. The system of claim 9, wherein the summarizer further comprises a user function stack that is configured to store a plurality of work items.

14. The system of claim 13, wherein the plurality of work items are at least one of function calls, a series of instructions, or a sequence of steps.

15. The system of claim 14, wherein the summarizer further comprises a task queue configured to store a pointer to a work item of the plurality of work items stored in the user function stack.

16. The system of claim 9, wherein the work division strategy utilizes both the host and the storage controller and merges the partial results from the storage controller with the results from the host.

17. A method comprising:
receiving, from a host, a work item;
determining a current workload of a storage controller on a solid state drive (SSD); and
determining a work division strategy that utilizes at least one of the host or the storage controller based on the current workload of the storage controller.

18. The method of claim 17, further comprising executing the work item based on the determined work division strategy.

19. The method of claim 17, wherein determining the current workload is a continuous operation.

20. The method of claim 17, wherein the work division strategy utilizes both the host and the storage controller and merges the partial results from the storage controller with the results from the host.
